(19) United States
(12) Patent Application Publication
(10) Pub. No.: US 2017/0331764 A1
(43) Pub. Date: Nov. 16, 2017

(54) SCHEDULING TRAFFIC IN A TELECOMMUNICATIONS NETWORK

(71) Applicant: ARIA NETWORKS LIMITED, Bath (GB)

(72) Inventor: Andrea CELLETTI, Chippenham Wiltshire (GB)

(73) Assignee: ARIA NETWORKS LIMITED, Bath (GB)

(21) Appl. No.: 15/531,368

(22) PCT Filed: Nov. 27, 2015
(86) PCT No.: PCT/GB2015/053633

§ 371 Date: May 26, 2017

(30) Foreign Application Priority Data
Nov. 28, 2014 (GB) 1421164.3

(51) Int. Cl. H04L 12/911; H04L 12/729

(52) U.S. Cl. CPC H04L 47/826; H04L 45/125; H04L 47/823

(57) ABSTRACT

A system for determining an optimal schedule for transmitting data from a source node to a destination node in a telecommunications network. The source node is connected to a plurality of egress links. The system comprises a schedule generator for generating a plurality of candidate schedules. The schedule generator is configured to automatically generate a candidate schedule for each egress link of the source node by selecting a first window of time, determining a highest throughput route starting at the egress link during the first window of time based on predicted link utilisations, and if the throughput of the highest throughput route is not sufficient to transport all the data during the first window of time, selecting one or more subsequent windows of time and, for each subsequent window of time, determining a highest throughput route starting at the egress link during the subsequent window of time based on predicted link utilisations until a candilate schedule for transferring all the data has been defined. The system also comprises a schedule selector for automatically selecting a best candidate schedule from the plurality of candidate schedules based on the time taken to transfer all the data across the network.

### FIELD OF THE INVENTION

This invention relates to systems, methods and computer code for scheduling the transfer of data across a telecommunications network. The invention is particularly suited for scheduling an internal data transfer across a telecommunications network whilst maintaining normal services for customers.

### BACKGROUND

There is a need for network operators to manage the routing of services through a network so that an acceptable quality of service can be delivered. For example, services may be routed to ensure that a class 1 service is delivered to its destination within an acceptable timeframe, as specified in a service level agreement. To achieve this, network operators route all the services being provided in such a way that there is sufficient capacity on the relevant routes to ensure that the class 1 service can be transported within an acceptable timeframe.

There are times when a network operator must also transport its own data across the network for maintenance or other reasons. For example, it may be required to route a large data set across the network from one data centre to another in order to meet a practical storage or commercial requirement. This presents a problem because transferring the data set uses up network capacity, risking disruption to more unpredictable customer services.

A known technique for resolving this problem is to partition the network into an external network for serving customers and an internal network for serving the network operator's maintenance traffic. For example, referring to FIG. 1 a partitioned network 102 comprises an external network 104 for serving customers such as external devices 106 and 108 and external networks 110 and 112, while an internal network 114 is provided for carrying out a data transfer for the network operator from data centre 116 to data centre 118. The external network 104 comprises nodes P1 to P7 with links between them. The external network also includes a link providing node P1 with access to the data centre 116 and a further link providing node P6 with access to the data centre 118. Similarly, the internal network 114 comprises nodes Pa to Pd with links between them, as well as a link providing the node Pa with access to the data centre 116 and a further link providing the node Pd with access to the data centre 118. Thus, each network 104, 114 has its own nodes, its own links, and its own links to the data centres 116, 118.

In a related approach, rather than partitioning the network into two separate networks, a proportion of the capacity of the network is reserved for internal data transfers.

However, these techniques create capacity redundancy leading to inefficiency because the internal network or the reserved capacity cannot be used for customer services even when internal data transfers are not being carried out.

It is accordingly an object of the invention to provide an improved technique for transferring data on a network internally.

### SUMMARY OF THE INVENTION

In a first aspect of the invention there is provided a system for determining an optimal schedule for transmitting data from a source node to a destination node in a telecommunications network. The source node is connected to a plurality of egress links. The system comprises a schedule generator for generating a plurality of candidate schedules. The schedule generator is configured to automatically generate a candidate schedule for each egress link of the source node by: selecting a first window of time, determining a highest throughput route starting at the egress link during the first window of time based on predicted link utilisations, and if the throughput of the highest throughput route is not sufficient to transport all the data during the first window of time, selecting one or more subsequent windows of time and, for each subsequent window of time, determining a highest throughput route starting at the egress link during the subsequent window of time based on predicted link utilisations until a candidate schedule for transferring all the data has been defined. The system also comprises a schedule selector for automatically selecting a best candidate schedule from the plurality of candidate schedules based on the time taken to transfer all the data across the network.

Preferably, determining a highest throughput route during a first window of time or during a subsequent window of time comprises determining a cumulative capacity of each link of the network based on the predicted link utilisations and routing at least a portion of the data based on the cumulative capacities.

Preferably, routing at least a portion of the data comprises using a generic routing engine.

Preferably, determining a cumulative capacity of a link comprises determining a difference between a total capacity of the link and a predicted utilisation of the link.

Preferably, the predicted link utilisations comprise a predicted utilisation value of each link in each of a series of time intervals, and each window of time is an integer number of consecutive time intervals.

Preferably, determining the cumulative capacity of a link during a window of time comprises, for each of the consecutive time intervals of the window, determining a difference between a total capacity of the link and the predicted utilisation value of the link in the time interval, and summing the differences.

Preferably, the time intervals are equal in duration.

Preferably, each time interval is one hour in duration.

Preferably, the system is configured to derive the predicted utilisation value of each link in a time interval by applying a generic routing engine to a demand matrix associated with the time interval.

Preferably, for each candidate schedule, the first window of time and any subsequent windows of time are consecutive.

Preferably, selecting a first window of time comprises identifying an earliest-starting and shortest window of time during which an egress link would have enough capacity for all the data.

Preferably, selecting the first window of time comprises identifying the earliest-starting and shortest window of time for which the egress link has a cumulative capacity greater than or equal to the quantity of data to be transferred across the network.

Preferably, selecting a subsequent window of time comprises identifying a consecutive and shortest window of time during which an egress link would have enough capacity for all the remaining data.

Preferably, selecting the subsequent window of time comprises identifying the next consecutive and shortest window of time during which the egress link has a cumulative capacity greater than or equal to the quantity of remaining data to be transferred across the network.

Preferably, the system is configured to fix a selected egress link as the first link of each highest throughput route of a candidate schedule.

Preferably, the plurality of candidate schedules comprises a number of candidate schedules equal to the number of egress links.

Preferably, the schedule generator is arranged to generate two or more candidate schedules in parallel.

Preferably, the schedule generator is arranged to abort generating a candidate schedule if a faster candidate schedule has already been found.

In a second aspect of the invention, there is provided a method of determining an optimal schedule for transmitting data from a source node to a destination node in a telecommunications network. The source node is connected to a plurality of egress links. The method comprises, for each egress link of the source node, automatically generating a candidate schedule by: selecting a first window of time, determining a highest throughput route starting at the egress link during the first window of time based on predicted link utilisations, and if the throughput of the highest throughput route is not sufficient to transport all the data during the first window of time, selecting one or more subsequent windows of time and, for each subsequent window of time, determining a highest throughput route starting at the egress link during the subsequent window of time based on predicted link utilisations until a candidate schedule for transferring all the data has been defined. The method also comprises automatically selecting a best candidate schedule from the plurality of candidate schedules based on the time taken to transfer all the data across the network.

Preferably, determining a highest throughput route during a first window of time or during a subsequent window of time comprises determining a cumulative capacity of each link of the network based on the predicted link utilisations and routing at least a portion of the data based on the cumulative capacities.

Preferably, routing at least a portion of the data comprises using a generic routing engine.

Preferably, determining a cumulative capacity of a link comprises determining a difference between a total capacity of the link and a predicted utilisation of the link.

Preferably, the predicted link utilisations comprise a predicted utilisation value of each link in each of a series of time intervals, and each window of time is an integer number of consecutive time intervals.

Preferably, determining the cumulative capacity of a link during a window of time comprises, for each of the consecutive time intervals of the window, determining a difference between a total capacity of the link and the predicted utilisation value of the link in the time interval, and summing the differences.

Preferably, the time intervals are equal in duration.

Preferably, each time interval is one hour in duration.

Preferably, the method comprises deriving the predicted utilisation value of each link in a time interval by applying a generic routing engine to a demand matrix associated with the time interval.

Preferably, for each candidate schedule, the first window of time and any subsequent windows of time are consecutive.

Preferably, selecting a first window of time comprises identifying an earliest-starting and shortest window of time during which an egress link would have enough capacity for all the data.

Preferably, selecting the first window of time comprises identifying the earliest-starting and shortest window of time for which the egress link has a cumulative capacity greater than or equal to the quantity of data to be transferred across the network.

Preferably, selecting a subsequent window of time comprises identifying a consecutive and shortest window of time during which an egress link would have enough capacity for all the remaining data.

Preferably, selecting the subsequent window of time comprises identifying the next consecutive and shortest window of time during which the egress link has a cumulative capacity greater than or equal to the quantity of remaining data to be transferred across the network.

Preferably, fixing a selected egress link as the first link of each highest throughput route of a candidate schedule.

Preferably, the plurality of candidate schedules comprises a number of candidate schedules equal to the number of egress links.

Preferably, the method comprises generating two or more candidate schedules in parallel.

Preferably, the method comprises aborting generating a candidate schedule if a faster candidate schedule has already been found.

In a third aspect of the invention, there is provided computer program code which when run on a computer causes the computer to perform a method according to the second aspect.

In a fourth aspect of the invention, there is provided a carrier medium carrying computer readable code which when run on a computer causes the computer to perform a method according to the second aspect.

In a fifth aspect of the invention, there is provided a computer program product comprising computer readable code according to the third aspect.

In a sixth aspect of the invention, there is provided an integrated circuit configured to perform a method according to the second aspect.

In a seventh aspect of the invention, there is provided an article of manufacture for detecting a selected mode of household use, the article comprising: a machine-readable storage medium; and executable program instructions embodied in the machine readable storage medium that when executed by a programmable system causes the system to perform a method according to the second aspect.

In an eighth aspect of the invention there is provided a device for detecting a selected mode of household use, the device comprising: a machine-readable storage medium; and executable program instructions embodied in the machine readable storage medium that when executed by a programmable system causes the system to perform a method according to the second aspect.

### DESCRIPTION OF THE DRAWINGS

The invention will now be described in detail with reference to the following drawings of which:

FIG. 1 is a schematic diagram of an arrangement of internal and external networks in accordance with the prior art;

FIG. 2 is a schematic diagram of a single network through which predictable traffic may be scheduled in accordance with an embodiment of the invention;

FIG. 3 is a schematic diagram illustrating utilisation per link per hour of the network of FIG. 2;

FIG. 4 is a network diagram showing a greenfield topology of a network through which predictive traffic may be scheduled in accordance with an embodiment of the invention;

FIG. 5 is a schematic diagram showing the construction of a table of the remaining capacity per link per epoch and the remaining cumulative capacity per link per group of consecutive epochs of the network of FIG. 4;

FIG. 6 is a schematic diagram illustrating building a network corresponding to a chosen time window by labelling each link of the greenfield topology of FIG. 4 with its cumulative capacity over the chosen epoch or epochs;

FIG. 7 is a network diagram of the greenfield topology of FIG. 4 annotated to show a target demand for scheduling the transfer of a data set from an identified source node to an identified destination node;

FIG. 8 is a cumulative capacity table of a selected start link annotated to illustrate the methodology of an embodiment of the invention according to which a the transfer of a data set is scheduled, assuming that the first link used is the selected start link;

FIG. 9 is a schematic diagram showing a branching structure resulting from exploring different scheduling options depending on which link is selected as the start link and which subsequent links belong to each explored route;

FIG. 10 is a flow chart illustrating a method of scheduling traffic in a network in accordance with an embodiment of the invention; and

FIG. 11 is a functional block diagram of a system for scheduling traffic in a network in accordance with an embodiment of the invention.

Throughout the drawings, like reference symbols refer to like features or steps.

### DETAILED DESCRIPTION OF THE INVENTION

When a network operator conducts an internal transfer of data, for example in order to relocate a data set to a new storage location, this transfer generates traffic. Traffic resulting from an internal transfer may be referred to as ‘predictable traffic’ because the network operator is in control of the data transfer and has full information, in advance, relating to the size of the data set to be transported, where it located at the start of the transfer, where it is to be delivered, and any routing protocol used.

By contrast, when a network operator provides data transfer services to a customer, this generates an amount of traffic on the network that depends on how much data the customer requests to transfer and when. Since the network operator does not know in advance exactly how much data the customer will request to transfer and when, traffic for providing services to customers may be referred to as ‘unpredictable traffic’.

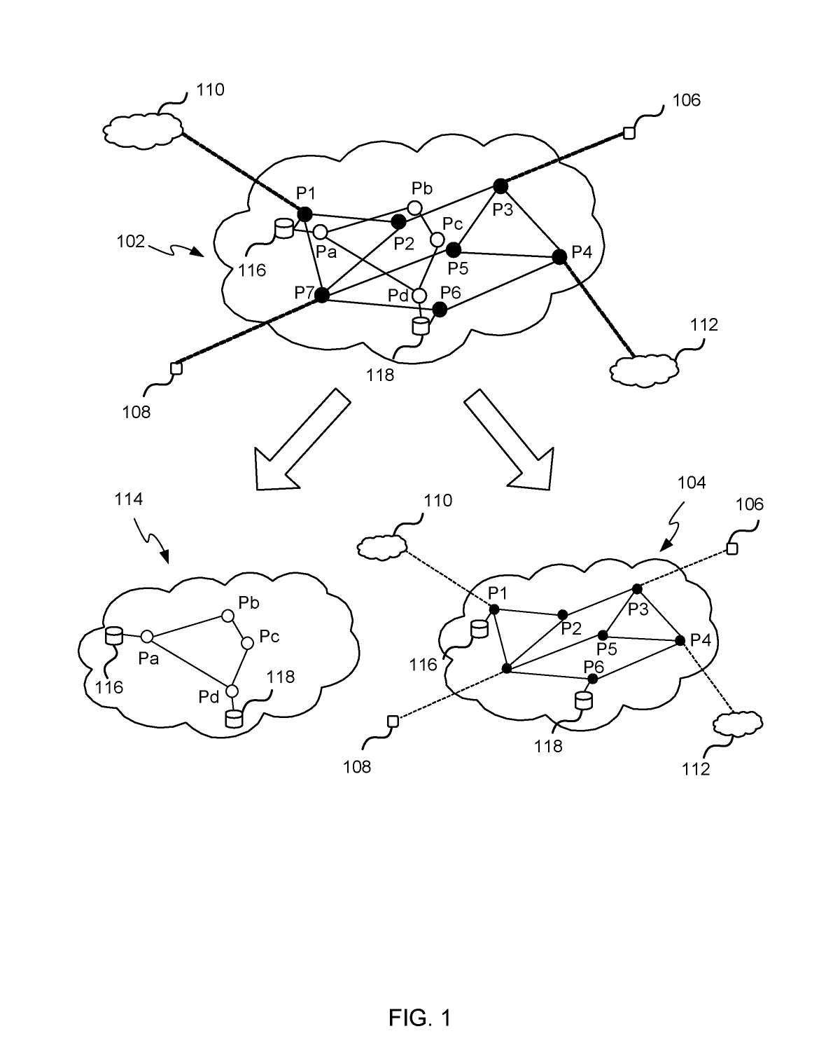

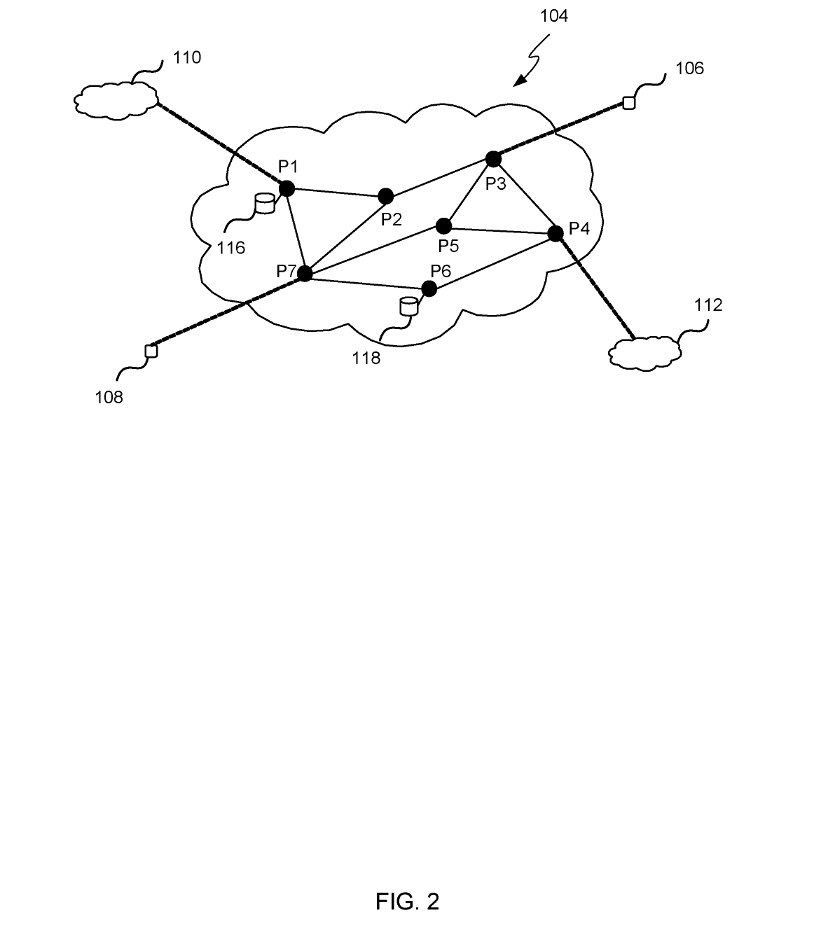

In accordance with embodiments of the invention, a schedule specifying when and how to transport predictable traffic without disrupting unpredictable traffic may be determined. A schedule is a plan for transporting traffic across a network that specifies one or more routes across the network along which the traffic is to be sent and a window of time that specifies when the traffic should be transported along the specified route or routes. Some schedules comprise only one route and one window of time during which traffic is to be transported along the route. Other schedules comprise a plurality of routes and a corresponding window of time for each route during which the traffic is to be transported along the route. If a schedule comprises a plurality of routes and windows of time, the windows of time may be consecutive or there may be time intervals between them. A route is a series of links connecting a source node where traffic starts its journey to a destination node where the traffic ends is journey. By determining a routing and timing schedule for transporting the predictable traffic that avoids using up capacity required by the unpredictable traffic, the schedule enables the same network to be used for the unpredictable and predictable traffic. A network 104 that can be used for both types of traffic without service disruption is shown in FIG. 2. This network is the same as the external network 104 of FIG. 1 but in this case a separate partitioned internal network 114 is not required for supporting predictable traffic because the predictable traffic can be accommodated using the routing and timing schedule. The topology of the network 104 shown in FIGS. 1 and 2 may be referred to as a ‘greenfield topology’ meaning that it represents only a network structure, and does not include any information relating to capacity or utilisation.

Embodiments of the invention use an approach for determining a routing and timing schedule that involves characterising the unpredictable traffic. By characterising the unpredictable traffic, potential opportunities for transferring some or all of the predictable traffic may be identified. For example, when there is less unpredictable traffic on a link or route of the network 104, there may be an opportunity to transfer some or all of the predictable traffic.

The amount of unpredictable traffic on a link or route of a network cannot be predicted with accuracy because it cannot be known how customers will consume data transport services in future periods of time. However, future demand can be estimated based on assumptions. In embodiments of the invention it is assumed that customer demands are cyclic and that patterns of behaviour in one cycle are repeated in a subsequent cycle. Thus, the demands placed on the network by customers in a past observation period, such as a past week, may be used to estimate the customer demands, and hence unpredictable traffic, on the network in a future week.

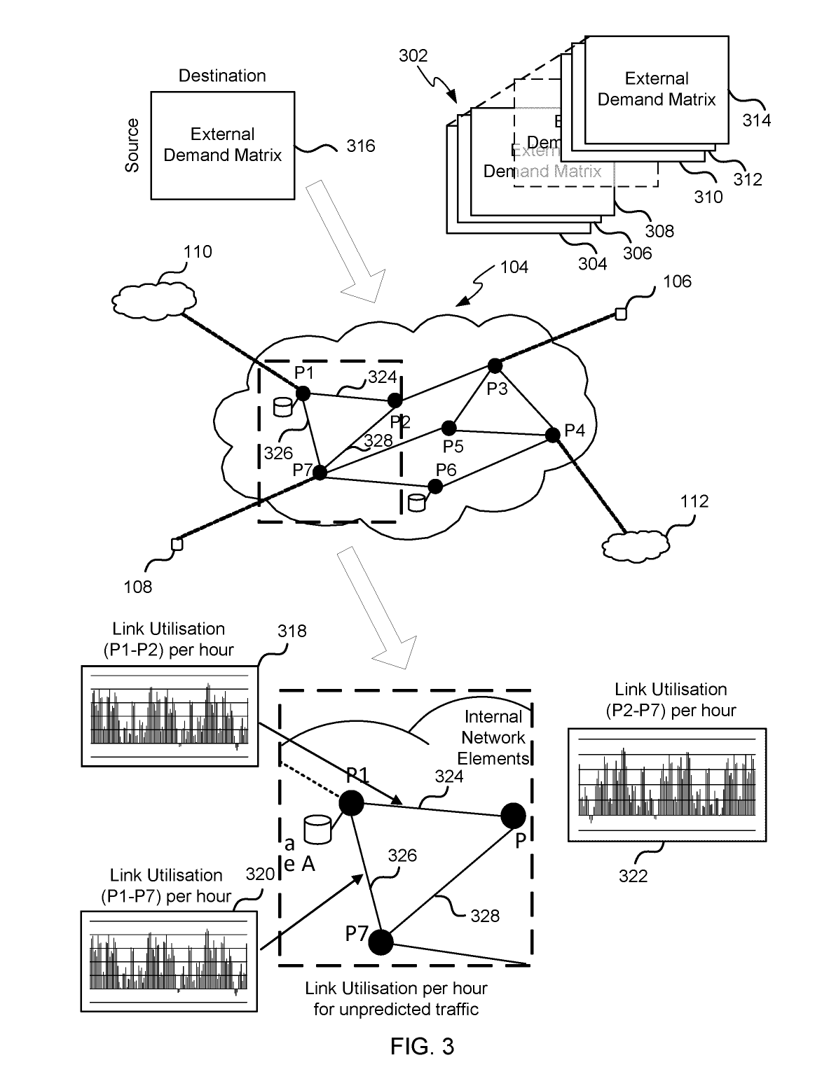

With reference to FIG. 3, a pattern of demands over a period of a week is represented by an hourly demand matrix 302. The hourly demand matrix 302 comprises a component demand matrix 304, 306, 308, 310, 312, 314 for each of the hours of the week which represents the demands placed on the network 104 by the network operator's customers during each respective hour of the week.

For example, in a component demand matrix 316, each row represents a different source node in the network 104 and each column represents a different destination node in the network 104. For each source and destination pair, there is a cell in the component demand matrix 316 that is populated with a value of the amount of capacity that was used by customers in the relevant hour of the observation week for routing data between the specified source and destination nodes.

A generic routing engine is used to apply the hourly demand matrix 302 to the greenfield topology of the network 104. The output of this operation is a routing plan which is used as an estimate of the actual routes followed by the services that were provided during the observation week. The routing plan is converted into individual utilisation values per link per hour, and as a result a graph of utilisation against time can be constructed for each link.

For example, referring again to FIG. 3, graphs 318, 320 and 322 of utilisation against time are shown for the links 324, 326 and 328, respectively. For example, the graph 318 shows the utilisation of the link 324 during the observation week. The graph 318 comprises a bar chart with each bar representing an hour of the week and the height of each bar representing the utilisation of the link 324 during that hour. Thus, the graphs 318, 320 and 322 represent an estimate of the utilisation per link per hour computed by a generic routing engine using the demands observed in the observation week as an input.

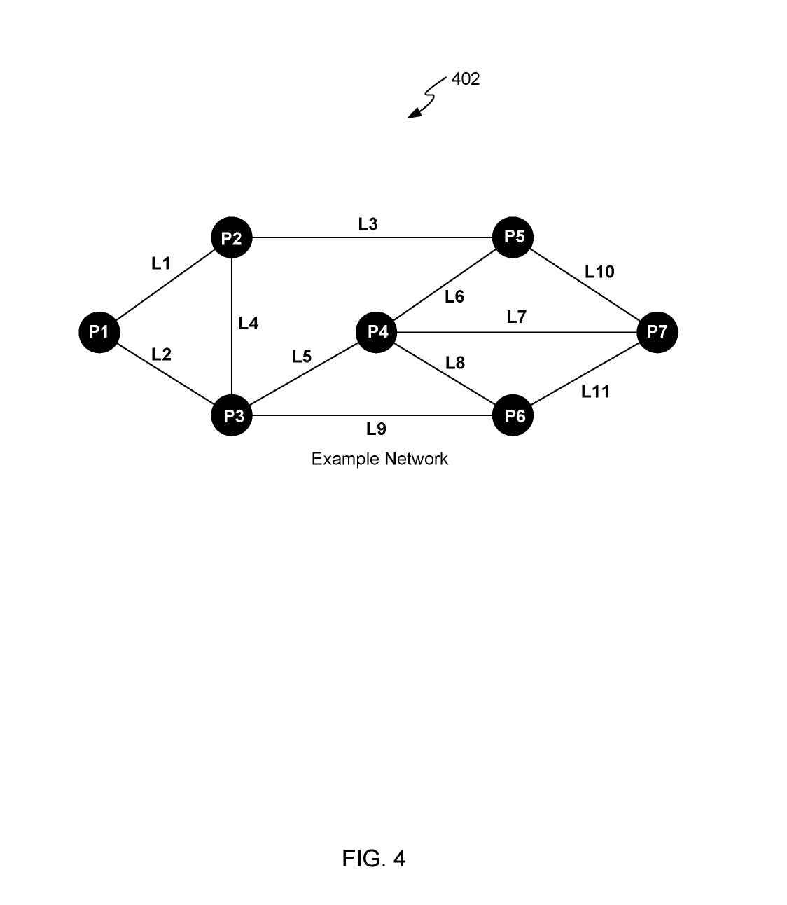

With reference to FIG. 4 there is shown a greenfield topology of a further example network 402 for which a routing and timing schedule for predictable traffic may be determined. The network 402 comprises nodes P1 to P7 and links L1 to L11.

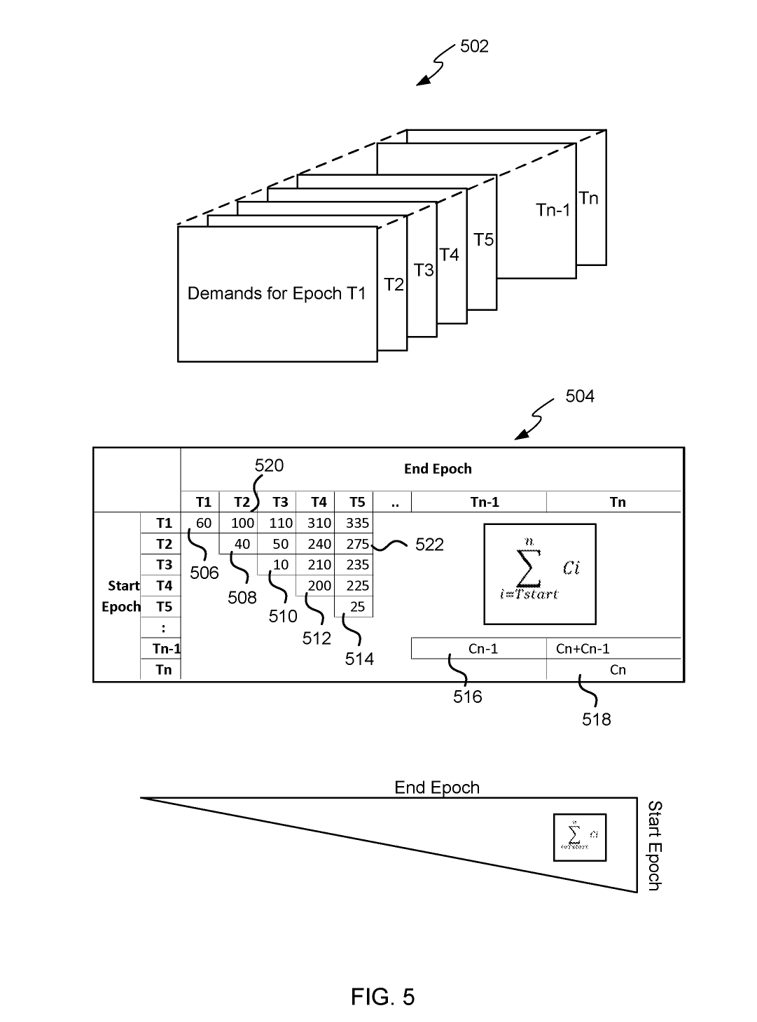

Referring to FIG. 5, in order to determine a routing and timing schedule for network 402, a demand matrix 502 similar to the hourly demand matrix 302 is used. While the hourly demand matrix 302 is based on dividing the observation period into hours, the demand matrix 502 is based on dividing the observation period into more general time intervals which may be referred to as epochs T1 to Tn and could, for example, be six minute intervals, thirty minute intervals, two hour intervals, and so on. Thus, the demand matrix 502 comprises a set of Tn component demand matrices, one for each epoch of the observation period.

A generic routing engine is used to apply the demand matrix 502 to the network 402 to generate utilisation per hour graphs for each of the links L1 to L11. For each link, this results in a bar chart of utilisation during the observation period with each bar representing the utilisation of the relevant link in an epoch. From the per epoch utilisation values—i.e. the heights of the bars of the bar chart—the remaining capacity of the link, and hence throughput of the link, during the epoch can be calculated. The remaining capacity is the utilisation of the link subtracted from the total capacity of the link. It is the capacity values of the links that form the basis for searching for opportunities for routing the predictable traffic without disrupting the unpredictable traffic.

From the bar chart, a table 504 of the capacity values may be constructed. Referring to FIG. 5, each of the diagonal cells of the table 504 corresponds to a bar of the bar chart. For example, the cell 506, relating to the first epoch T1, indicates a capacity of 60 which is the remaining capacity after taking into account the utilisation represented by the height of the first bar of the bar chart. Thus, after the estimated utilisation of the link by the unpredictable traffic has been taken into account, there is an estimated capacity of 60 remaining in the first epoch that could potentially be used for routing predictable traffic. Similarly, cell 508 indicates a capacity of 40 in epoch T2, cell 510 indicates a capacity of 10 in epoch T3, cell 512 indicates a capacity of 200 in epoch T4, cell 514 indicates a capacity of 25 in epoch T5, and more generally cell 516 indicates a capacity of Cn-1 in epoch Tn-1, and cell 518 indicates a capacity of Cn in epoch Tn.

Thus, for example, if the observation period is a week and each epochs is one hour, then there are 24×7=168 epochs (i.e. Tn=T₁₆₈). As a result, in this case there are 168 component demand matrices (one for each hour of the week), and there are 168 cells along the diagonal in the table 504 (i.e. Cn=C₁₆₈).

The table 504 also includes cells to the right of the cells on the diagonal indicating the cumulative capacity of the link in consecutive epochs. The cumulative capacity values are calculated from the capacity values on the diagonal on the basis that the rows of the table represent the start epoch of the consecutive epochs and the columns indicate the end epoch of the consecutive epochs. For example, for a window of time consisting of the consecutive epochs T1 and T2, there is indicated in cell 520 a cumulative capacity of 100. This is calculated by summing the capacity in T1 as indicated in cell 506 and the capacity in T2 as indicated in cell 508—i.e. 60+40=100. Similarly, as another example, the cumulative capacity during a window of time from T2 to T5 is indicated in cell 522 and calculated by summing the capacities of epochs T2, T3, T4 and T5 as indicated in cells 508, 510, 512 and 514, respectively—i.e. 40+10+200+25=275. There are no populated cells to the left of the cells on the diagonal because a window of time cannot end in an epoch earlier than the one in which it started.

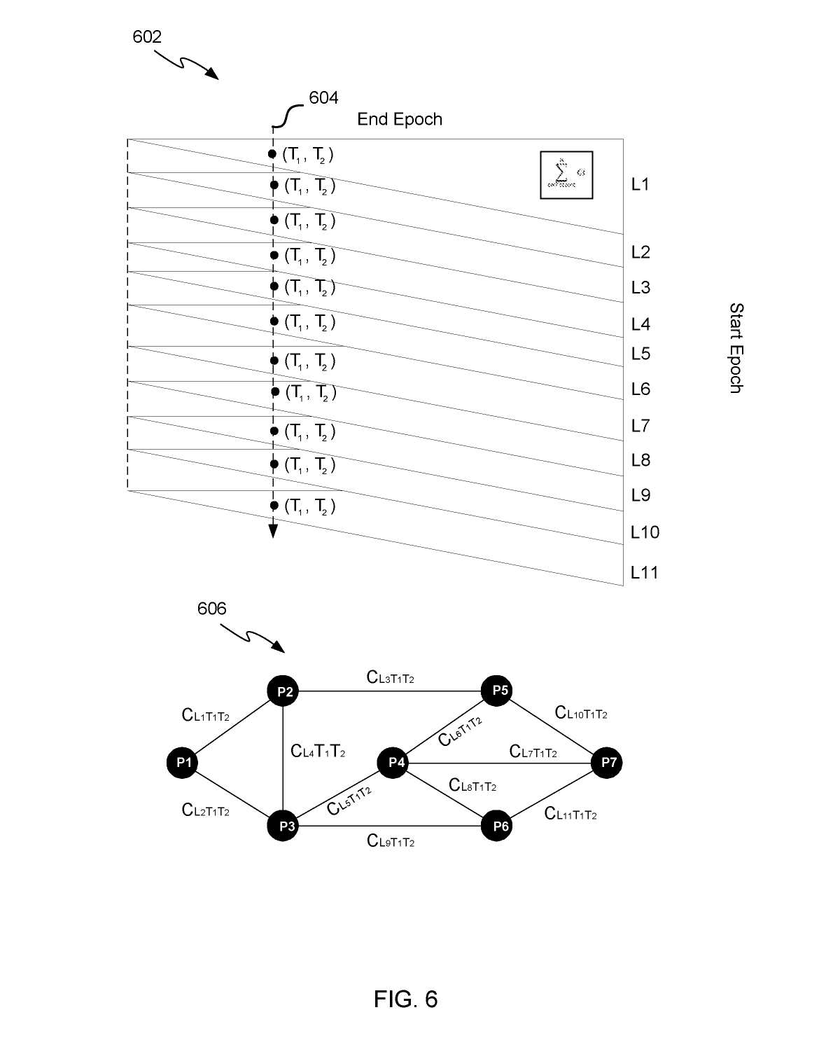

As indicated above, the table 504 shows the cumulative capacities for a link of the network 402. A table of cumulative capacities can be created for each link of the network 402 to create a stack 602 of cumulative capacity tables for the links L1 to L11 is shown in FIG. 6. As described above, each cell of the table 504 corresponds to a particular start epoch and a particular end epoch—i.e. to a particular window of time. Thus, when cumulative capacity tables are stacked one on top of the other, cells from different tables corresponding to the same window of time form a vertical column. For example, the vertical column 604 in FIG. 6 corresponds to the window of time T1 to T2.

The cumulative capacity values contained in a column of the tack 602 can be used to construct a network from the greenfield topology 402 by labelling each link with its cumulative capacity in a chosen window of time. Since the resulting constructed network corresponds to a window of time, such a network will be referred to as a ‘window network’ in this document. For example, the capacity values in the column 604 may be used to create a window network 606 in which each link is labelled with its cumulative capacity during the window of time T1 to T2. As shown in FIG. 6, the link L1 of the window network 606 is labelled with a cumulative capacity value C_{L1T1T2}. If the table 504 of FIG. 5 represents link L10 of the network 402, then it can be seen from cell 520 that C_{L10T1T2}=100.

A window network may be constructed for any window of time in the observation period. This is to say that a network with links labelled with their cumulative capacities may be constructed for any epoch and any set of consecutive epochs. Each window network thus specifies the amount of free capacity in the network per link during the relevant window and can be used to explore scenarios for routing predictable traffic. Thus, cumulative capacity values for the links of the network are used to route predictable traffic without disrupting unpredictable traffic, thereby protecting customer services.

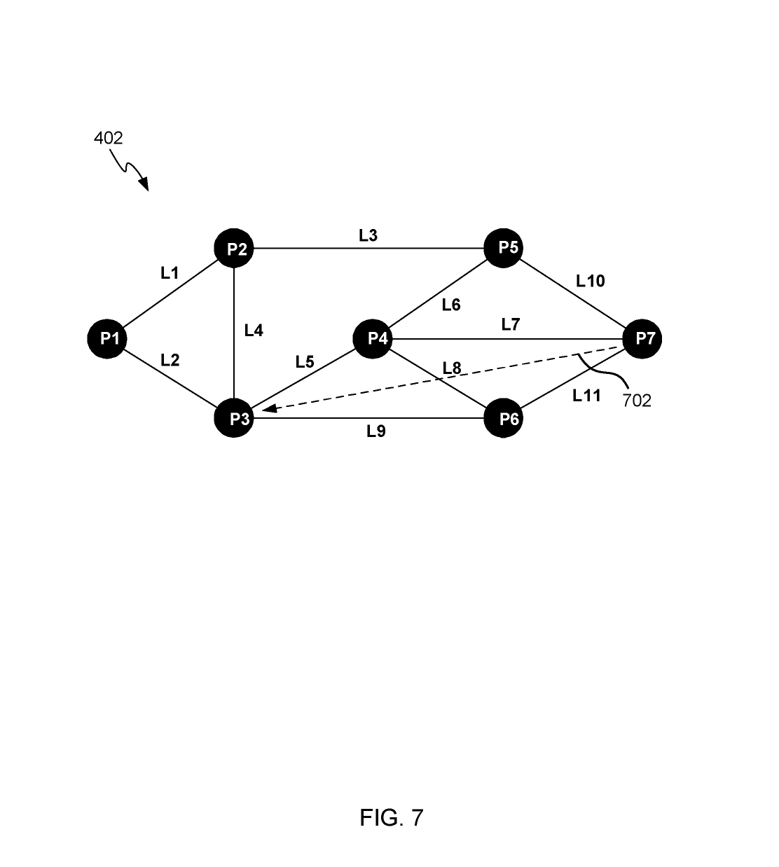

With reference to FIG. 7, an example target demand 702 is shown for the network 402. The target demand 702 requires the transportation of predictable traffic from node P7 to node P3 with a total capacity of C. There are many possibilities for routing this data transfer among the available capacity. For example, it should be determined when to start the data transfer and what route to use across the network. It could also be decided that, if capacity allows, the same route should be used for the duration of the transfer. Alternatively, a series of different routes could be used at different times if this enables the data set to be sent to the destination node P3 more quickly. Thus, in order to determine an appropriate routing and timing schedule, a search for an appropriate schedule among the many options is carried out.

The full set of options creates a burdensome search. As a result, it is advantageous to restrict the number of searched options to increase the speed of the search. A number of tactics for reducing the number of explored options, whilst still enabling a good result to be found, are described as follows.

Firstly, the format of the explored options may be restricted to a predetermined format. For example, it could be decided that the route for transporting data may be changed during the course of the data transfer if this enables the data set to be sent more quickly. In this case, it could be decided that a potential scheduling option for routing the data should comprise a first route during a first window of time, followed by a second route during a second window of time, and so on until all the data has been sent. A set of routing options of this format could be compared to determine which enables the data to be transported to the destination node most quickly. The quickest routing option is the result of the search.

Using this approach, a second assumption could be applied to restrict further the number of routing options to explore. The second assumption may be simply that the data transfer will begin in the first epoch T1. This is a suitable assumption because it is likely that the network operator will want to complete the internal data transfer as soon as possible.

A third restriction to reduce the size of the set of routing options to be searched may be applied. This may be that for routing schedule comprising more than one route consecutive route, the starting link of each route is the same. For example, if the data can be transferred by using a route A in window 1 followed by a route B in a window 2, routes A and B have the same starting link.

Following these three restrictions, a searching strategy may be applied as follows. There are only three possibilities for the starting link in network 402: any route must start with one of the three egress links L10, L7 and L11 which are connected to the start node P7. It is convenient to take each egress link in turn.

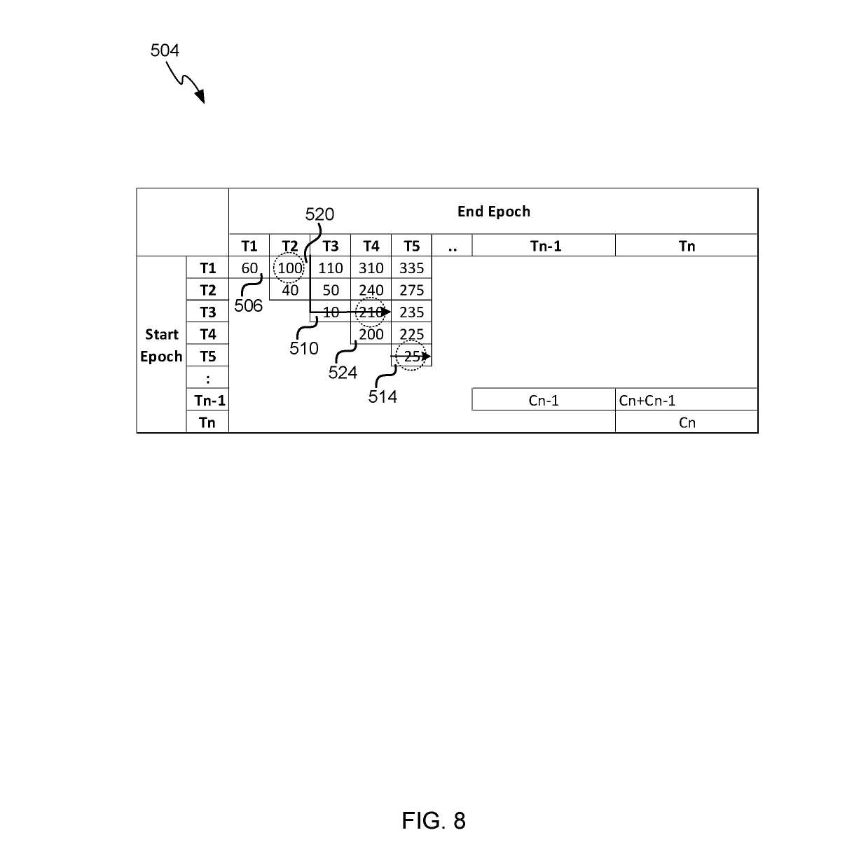

For example, routing options with L10 as a starting link are explored by first referring to the cumulative capacity table 504 of the link L10. Referring to FIG. 8, a suitable way of exploring the options starting in epoch T1 at link L10 is to identify the smallest number of epochs during which the full capacity C of the target demand could be transferred across the starting link L10. It can be seen from cell 506 of table 504 that in the first epoch T1, link L10 has a capacity of 60. If the required total capacity C is 90, the first epoch T1 does not provide enough time for all the data to be transported across link L10. Therefore, the next epoch is included. From cell 520 it can be seen that link L10 has a cumulative capacity of 100 in the window T1 to T2. Since 100 is greater than the required capacity C=90, the first two epochs T1 and T2 provide enough time for all the data to be transported across the first link L10. Thus, the window T1 to T2 provides a suitable starting point for the search.

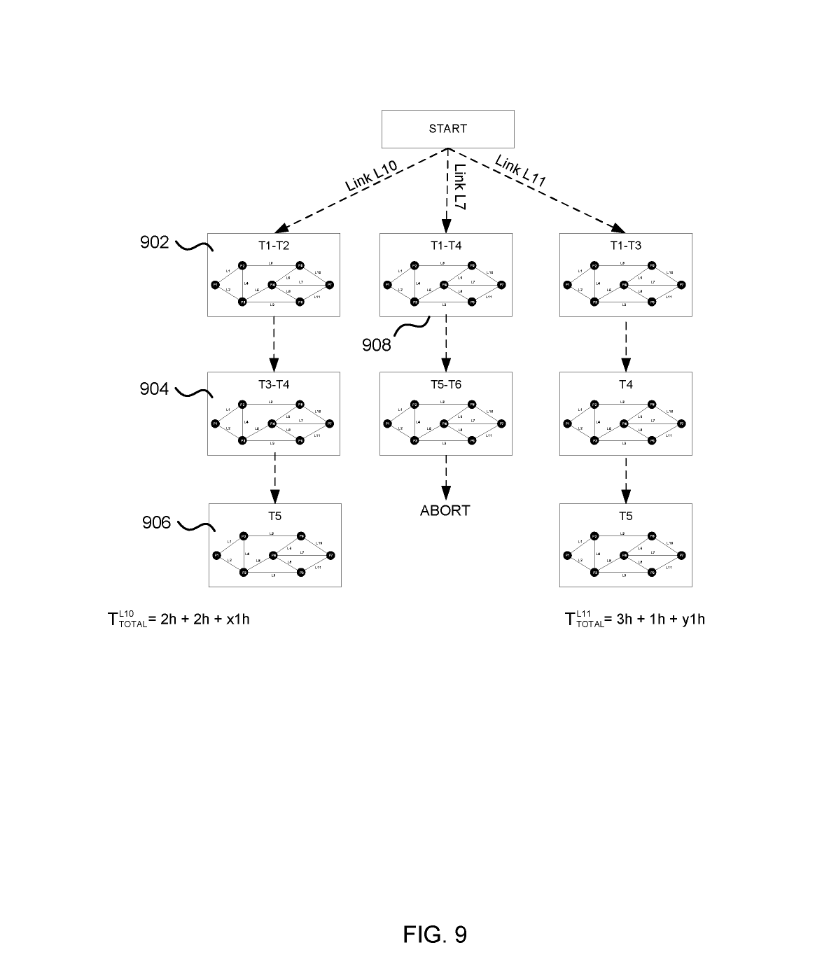

From this starting point, a window network 902 is generated for the window T1 to T2, as indicated in FIG. 9. It is desired to find a route for transporting as much of the data as possible during the window T1 to T2. For this purpose, a generic routing engine is applied to the window network 902 to find the highest throughput route. As explained, the first link, L10, has enough cumulative capacity in the window T1 to T2 to transport all the data. However, this may not apply to all the links of the window network 902, so it is possible that not all the data can be transported during the window T1 to T2. In this example, a capacity of 35 out of the total of 90 is transported during the window T1 to T2, leaving a remaining capacity of 55 still to be routed.

Another window of time, starting immediately with epoch T3, is required to attempt to route the remaining capacity of 55. A similar approach is taken for identifying a second window. Referring to FIG. 8, the row corresponding to a start epoch of T3 is consulted. The table 504 is used to find the shortest window of time during which the first link L10 can transport all the remaining capacity. From cell 510 it can be seen that there is not enough capacity (10<55) to transport all the remaining data across link L10. By including another epoch, it can be seen from cell 524 that there is a cumulative capacity of 210 during the window T3 to T4. This is more than the remaining capacity of 55, so the window T3 to T4 provides a suitable starting point for searching for the second route.

From this starting point, a window network 904 corresponding to the window T3 to T4 is generated, as indicated in FIG. 9. A generic routing engine is applied to the window network 904 to find the highest throughput route. In this example, a highest throughput route is found which can be used to transport a capacity of 50. This leaves a capacity of 5 still remaining, so a third window and a third route are required.

The third window of time starts immediately after the second window, at epoch T5. Referring to FIG. 8, the cell 514 indicates that the epoch T5 has a capacity of 25. Since this capacity value is more than the remaining capacity of 5 still to be transferred, the remaining capacity of 5 can be transported across link L10 during the epoch T5. Thus, the third window of time comprises just the epoch T5.

A window network 906 for the window T5 is generated, as indicated in FIG. 9. The highest throughput route of the window network 906 is determined using a generic routing engine and it is found that all the remaining data can be sent. In this example, the remaining capacity of 5 does not require the full epoch T5 to arrive at the destination node P3. Rather, a fraction of the total epoch is needed. The amount of time actually required depends on the capacity of the lowest capacity link of the highest throughput route. This lowest capacity may be used to work out the time taken to transport the final part of the data set to the destination node.

The total time taken for transporting the data set is then the sum of the windows plus the final window weighted by a coefficient, x, where x is greater than 0 but no greater than 1. For example, if the epochs are each one hour (1 h), the total time taken in this example may be expressed as T_{TOTAL}=2 h+2 h+x1 h. If the coefficient x is equal to 0.4, this schedule routes all the data in a total time of T_{TOTAL}=4 h and 24 minutes (‘4 h24’). The coefficient x depends on how much of the final epoch is needed for sending the remaining data. Its value may be calculated by dividing the amount of remaining data by the cumulative capacity of the final epoch. For example, if 4M of data are to be sent in the final epoch and the final epoch has a cumulative capacity of 10M, we have x=4M/10M=0.4.

Referring to FIG. 9, this process is repeated for the other egress links, L7 and L11 to determine how long it would take to route all the data starting with each of these links. As shown in FIG. 9, the shortest window starting with T1 during which all the data could be transported across link L7 is T1 to T4. Therefore, a window network 908 corresponding to the window T1-T4 is generated. Not all the data can be transported during this window, so another window is needed. The shortest window starting with T5 during which the remaining data can be transported across link L7 is T5 to T6. This creates a trigger because by requiring at least some of the sixth epoch T6, this schedule will take more than 5 hours, which is longer than the 4 h24 schedule explored already. As a result, there is no point in continuing to explore the routing schedule starting at link L7. The exploration is aborted. This avoids unnecessary computation and thus speeds up the search. The three columns in FIG. 9 representing each of the explorations of different starting links may be referred to as branches of the search and the aborting of an exploration because a faster schedule has already be found may be referred to as pruning the branches. It will be appreciated that in this example there is one branch per starting link and each branch does not bifurcate. However, in other examples, if each time a further window of time is needed to route some remaining data a new starting link may be randomly selected, then the branches will bifurcate and the branching structure will be more complex. In this case, pruning may still be applied and will create useful savings in the computation burden and speed up the search.

Finally, in the example of FIG. 9, the last starting link L11 is explored. This branch comprises a first route during the window T1 to T3, a second route during epoch T4, and a third route in epoch T5. The total time required for this schedule is T_{TOTAL}=3 h+1 h+y1h. If y=0.3, we have T_{TOTAL}=4 h20.

Thus, three schedules have been identified and the fastest is found to start at link L11, taking 4 h20 to transport all the data. The result of this search is a routing schedule consisting of the first route during the window T1 to T3, the second route during epoch T4, and the third route in epoch T5.

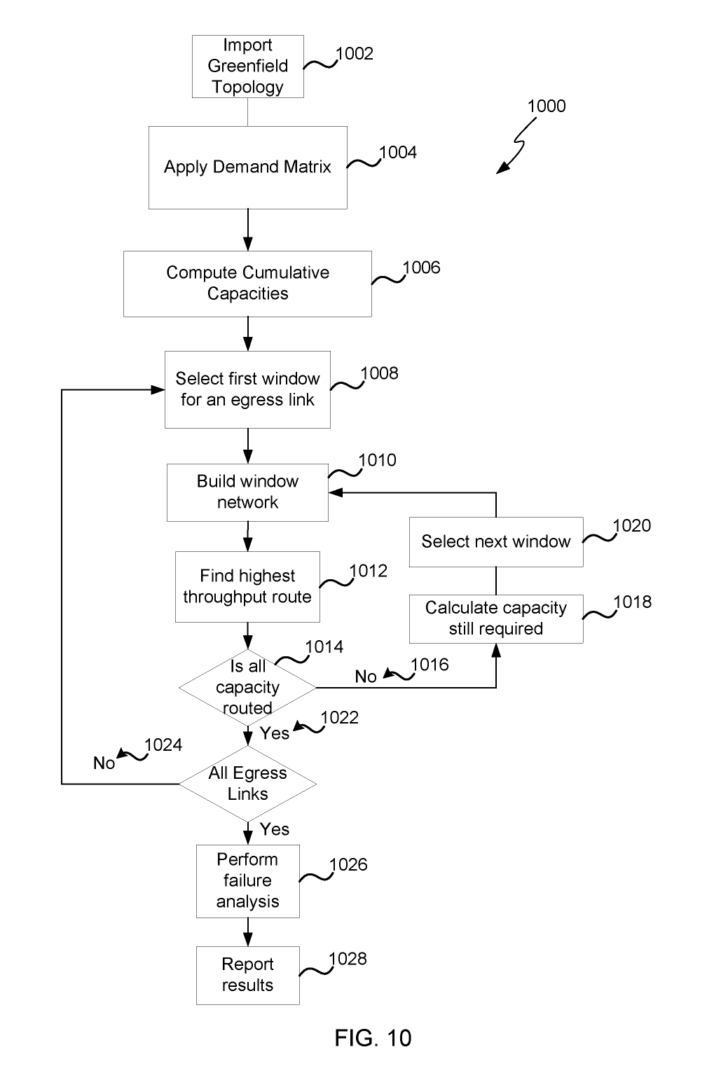

With reference to FIG. 10, a method of searching for a fastest routing schedule according to an embodiment of the invention will be described. In general, the searching method may be applied to any type of network such as a data transport network or a telecommunications network. The searching method may also suitably be applied to other types of networks such as passenger transport networks, for example a railway network. A network is to be understood as a set of nodes connected by links for transporting a load such as data or passengers from one node to another. In the example of a data transport network, the nodes may for example include provider routers (‘P nodes’) and edge routers (‘PE nodes’); an optical-electrical-optical (OEO) amplifier such as a 3R amplifier for reshaping, retiming and retransmitting a signal; an OEO switch such as an optical cross connect (OXC); a 1R amplifier for retransmitting a signal; a digital cross connect (DXC) switch such as an optical add-drop multiplexer (OADM). Links of the data transport network may include IP links and optical links for example provided by fibre optic cabling. In the example of a telecommunications network, nodes may include a client device such as a mobile telephone and a radio transceiver at a base station, while a link could comprise an over-the-air radio channel connecting the radio transceiver of the base station and the client device.

A greenfield topology of the network is imported at step 1002 into a computer system for processing. As indicated above, the greenfield topology represents a plan of the network including nodes and links but excluding information specifying the services being run on the network. Data describing the services is provided by a demand matrix which specifies the services by hour or by another time interval (‘epoch’), and is applied at step 1004 to the greenfield topology by a generic routing engine. As result of this step, the utilisation of each link in each epoch may be determined.

Cumulative capacities per link per window of time are computed at step 1006. Each window comprises one or more consecutive epochs. The cumulative capacity of a link in a window of time is the total amount of data that can be transported across the link during the period of time. For each epoch, the capacity of a link is the total capacity of the link less the utilisation of the link. Thus, the capacity is the capacity left over after the services specified in the demand matrix have been taken into account. As a result, cumulative capacities may be used to explore options for routing internal data transfers without disrupting services on the network.

In general, it is advantageous for network operators to complete internal data transfers as quickly as possible and as early as possible. Data transport schedules that have high throughput routes and early start times are therefore desirable. It is also generally desirable to minimise the impact of a link failure on the planned route. This may be implemented, for example, by requiring that if an internal data transfer needs to be rerouted, the rerouting does not use more than a threshold percentage of the capacity of the new route.

For example, a network operator might require an internal transfer of 2Tb of data from Madrid to Tokyo with the additional requirement that rerouting in the event of failure takes up no more than 80% of the capacity of the new route.

With these requirements in place, a search for a suitable routing schedule may be conducted. The object of the search is to find a route for transferring the data across the network in an acceptable time frame and satisfying the failure requirement. The output of the search may comprise more than one route, for example routes 1, 2 and 3, to be used consecutively in consecutive windows of time. Alternatively there may be gaps of time between the subsequent windows of time. In any case, a search is conducted and the best routing schedule or a shortlist of schedules is determined. For example, a best schedule may have an earliest completion time when all the data has been transferred. Alternatively, a best schedule may be the fastest—i.e. may take a shortest amount of time from start to finish, even if it has a later completion time. For example, if choosing between a one-hour transfer completing tomorrow and a six-hour window completing today, the faster one-hour transfer tomorrow may be preferred. A shortlist of schedules may comprise the five fastest schedules satisfying the failure requirement. After reviewing the shortlist the network operator might, for example, chose the second fastest schedule if it has a much smaller impact to network services in the event of failure.

To speed up the search, the pool of schedules to be explored may be restricted. Following the approach described above, a schedule for each egress link from the source node may be determined. In this approach, starting with one of the egress links (i.e. one of the links connected to the start node), a first window is selected for the egress link at step 1008 by identifying the first window during which the egress link has a cumulative capacity equal to or greater than the capacity required to transfer all the data. This provides a suitable starting point for the search. The cumulative capacities corresponding to the selected first window are used to build a window network at step 1010 and a highest throughput route through this window network is determined at step 1012 using a generic routing engine.

There is a question 1014 as to whether all the data has now been routed. If the highest throughput route only allows part of the data to be transferred (arrow 1016), the process cycles back to find a next suitable window for routing some more data. At step 1018 the amount of capacity still required to route the remaining data is calculated. On the basis of the required capacity, at step 1020 a subsequent shortest window during which the egress link has a cumulative capacity equal to or greater than the required capacity is identified. Steps 1010, 1012 and 1014 of the process are then repeated to find a highest throughput route during the second window of time for transporting some more of the data. The cycle is repeated as necessary until a schedule for routing all the data has been identified.

If all the capacity has been routed (arrow 1022), the process is repeated (arrow 1024) to find a schedule with each egress link as a starting link.

As this process is carried out, the search takes on a branching structure because each routing schedule, which may comprises a series of routes in different windows, may be considered as a branch. In the approach of FIG. 10 there is one branch per egress link. As indicated above, other embodiments may involve a more complex branching structure in which the starting link of each window may be chosen freely, so that the branches repeatedly split to reflect the starting link options at the beginning of every new window. In any case, the search may be simplified by pruning a schedule if a better schedule, for example a faster schedule, has already been found. This is to say that the process of determining a schedule may be aborted part way if it is already slower than a schedule previously found. A branch may also be pruned for other reasons, for example if it does not satisfy a failure requirement—this would apply to a schedule requiring 95% of the capacity of a back-up route in the event of failure in the example above. Alternatively, failure analysis may be performed for all identified schedules in a separate step 1026.

Other techniques for speeding up the search may be used such as parallelising the computations for the different branches so they can be processed simultaneously.

Finally, the results of the search are reported at step 1028. As described, the results could comprise a fastest routing schedule—for example, a schedule for routing the 2Tb of data from Madrid to Tokyo starting on a Monday at a local time of 9 am in Madrid and completing the following day at a local time of 10:32 pm in Tokyo. Alternatively, the five fastest schedules could be reported, each with an indication of how much of the capacity of a back-up route would be needed in the event of a failure of the primary route.

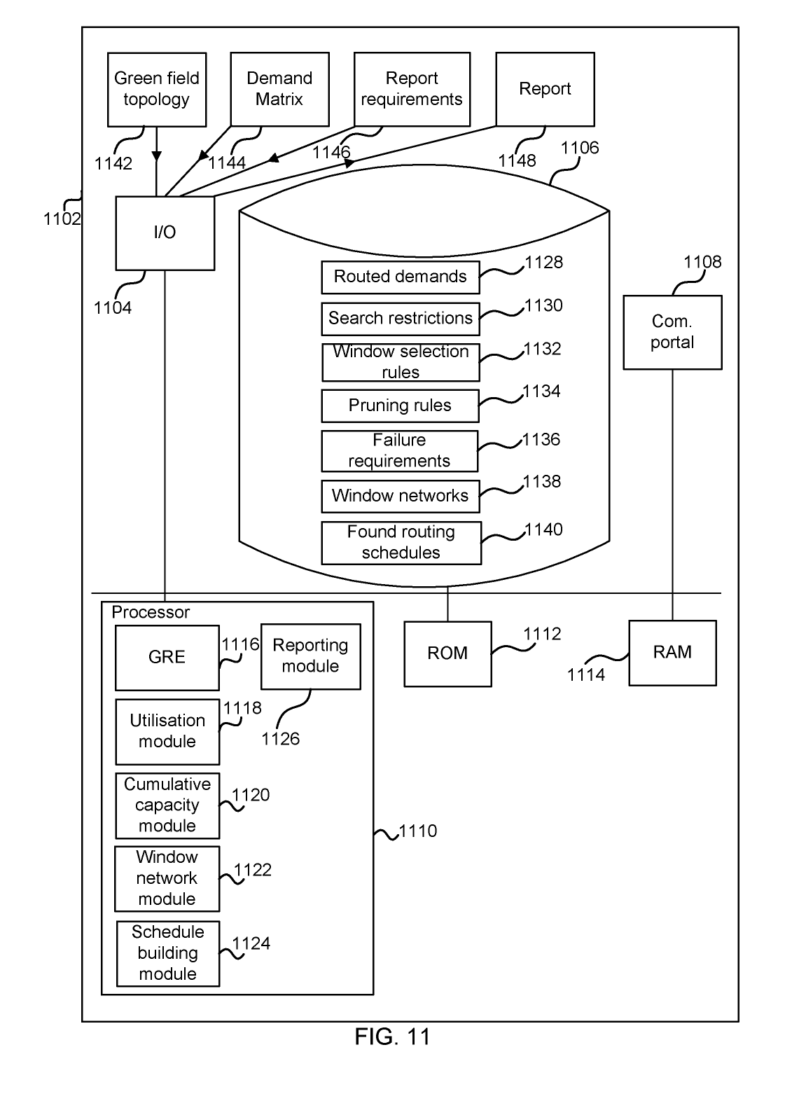

Searching for a suitable schedule for routing traffic in a network may be implemented by a system 1802 as shown in FIG. 11. The system 1102 comprises an input and output interface element 1104, a database 1106, a communications portal 1108, a processor 1110, read only memory (ROM) 1112 and random access memory (RAM) 1114. The processor 1110 includes a generic routing engine 1116 for carrying out the step 1004 of applying a demand matrix to a greenfield topology and for carrying out the step 1012 of finding highest throughput routes. The processor 1110 also includes a utilisation module 1118 for determining the utilisation per link of a network; a cumulative capacity module 1120 for carrying out the step 1006 of computing cumulative capacities per link per window of time; a window network module 1122 for carrying out the step 1010 of building window networks; a schedule building module 1124 for managing the cycling back of the method 1000 to find further highest throughput routes for routing remaining data; and a reporting module 1126 for constructing a report of found routing schedules.

The database 1106 stores routed demands 1128 produced by the generic routing engine 1116 by applying a demand matrix to a greenfield topology; search restrictions 1130 such as limiting the search to schedules whose routes share the same starting link; window selection rules 1132 specifying how to select a starting window, for example by finding the shortest window during which a first link has enough cumulative capacity to route all the data to be transported; pruning rules 1134 specifying when to abort the construction of a routing schedule; failure requirements 1136 specifying limitations on the consequences of a failure of a primary route; window networks 1138 that have been created by the window network module 1122; and found routing schedules 1140 which are saved as they are created so that the best schedule or schedules can be reported by the reporting module 1126.

The interface element 1104 is arranged to receive a greenfield topology 1142, a demand matrix 1144 and report requirements—for example that a shortlist is required—as inputs, and to deliver a report 1148 of one or more selected routing schedules as an output.

Functions relating to scheduling traffic in a network may be implemented on computers connected for data communication via the components of a packet data network. Although special purpose devices may be used, such devices also may be implemented using one or more hardware platforms intended to represent a general class of data processing device commonly used so as to implement the event identification functions discussed above, albeit with an appropriate network connection for data communication.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. energy usage measurements for a time period already elapsed. The software code is executable by the general-purpose computer that functions as the server or terminal device used for scheduling traffic in a network. In operation, the code is stored within the general-purpose computer platform. At other times, however, the software may be stored at other locations and/or transported for loading into the appropriate general-purpose computer system. Execution of such code by a processor of the computer platform or by a number of computer platforms enables the platform(s) to implement the methodology for scheduling traffic in a network, in essentially the manner performed in the implementations discussed and illustrated herein.

Those skilled in the art will be familiar with the structure of general purpose computer hardware platforms. As will be appreciated, such a platform may be arranged to provide a computer with user interface elements, as may be used to implement a personal computer or other type of work station or terminal device. A general purpose computer hardware platform may also be arranged to provide a network or host computer platform, as may typically be used to implement a server.

For example, a server includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications.

A user terminal computer will include user interface elements for input and output, in addition to elements generally similar to those of the server computer, although the precise type, size, capacity, etc. of the respective elements will often different between server and client terminal computers. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load.

Hence, aspects of the methods of scheduling traffic in a network outlined above may be embodied in programming. Program aspects of the technology may be thought of as “products” or “articles of manufacture” typically in the form of executable code and/or associated data that is carried on or embodied in a type of machine readable medium and/or in a plurality of such media. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the organisation providing scheduling traffic in a network services into the scheduling traffic in a network computer platform. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the scheduling traffic in a network, etc. shown in the drawings. Volatile storage media include dynamic memory, such as main memory of such a computer platform. Tangible transmission media include coaxial cables; copper wire and fibre optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Although the present invention has been described in terms of specific exemplary embodiments, it will be appreciated that various modifications, alterations and/or combinations of features disclosed herein will be apparent to those skilled in the art without departing from the spirit and scope of the invention as set forth in the following claims.

1. A system for determining an optimal schedule for transmitting data from a source node to a destination node in a telecommunications network, wherein the source node is connected to a plurality of egress links, the system comprising:
a schedule generator for generating a plurality of candidate schedules, the schedule generator being configured to automatically generate a candidate schedule for each egress link of the source node by:
selecting a first window of time,
determining a highest throughput route starting at the egress link during the first window of time based on predicted link utilisations, and
if the throughput of the highest throughput route is not sufficient to transport all the data during the first window of time, selecting one or more subsequent windows of time and, for each subsequent window of time, determining a highest throughput route starting at the egress link during the subsequent window of time based on predicted link utilisations until a candidate schedule for transferring all the data has been defined; and
a schedule selector for automatically selecting a best candidate schedule from the plurality of candidate schedules based on the time taken to transfer all the data across the network.

2. A system according to claim 1, wherein determining a highest throughput route during a first window of time or during a subsequent window of time comprises determining a cumulative capacity of each link of the network based on the predicted link utilisations and routing at least a portion of the data based on the cumulative capacities.

3. A system according to claim 2, wherein routing at least a portion of the data comprises using a generic routing engine.

4. A system according to claim 2, wherein determining a cumulative capacity of a link comprises determining a difference between a total capacity of the link and a predicted utilisation of the link.

5. A system according to claim 1, wherein the predicted link utilisations comprise a predicted utilisation value of each link in each of a series of time intervals, and each window of time is an integer number of consecutive time intervals.

6. A system according to claim 5, wherein determining the cumulative capacity of a link during a window of time comprises, for each of the consecutive time intervals of the window, determining a difference between a total capacity of the link and the predicted utilisation value of the link in the time interval, and summing the differences.

7. A system according to claim 5, wherein the time intervals are equal in duration.

8. A system according to claim 7, wherein each time interval is one hour in duration.

9. A system according to claim 5, comprising deriving the predicted utilisation value of each link in a time interval by applying a generic routing engine to a demand matrix associated with the time interval.

10. A system according to claim 1, wherein, for each candidate schedule, the first window of time and any subsequent windows of time are consecutive.

11. (canceled)

12. (canceled)

13. (canceled)

14. (canceled)

15. (canceled)

16. (canceled)

17. (canceled)

18. (canceled)

19. A method of determining an optimal schedule for transmitting data from a source node to a destination node in a telecommunications network, wherein the source node is connected to a plurality of egress links, the method comprising:
for each egress link of the source node, automatically generating a candidate schedule by:
selecting a first window of time,
determining a highest throughput route starting at the egress link during the first window of time based on predicted link utilisations, and
if the throughput of the highest throughput route is not sufficient to transport all the data during the first window of time, selecting one or more subsequent windows of time and, for each subsequent window of time, determining a highest throughput route starting at the egress link during the subsequent window of time based on predicted link utilisations until a candidate schedule for transferring all the data has been defined; and
automatically selecting a best candidate schedule from the plurality of candidate schedules based on the time taken to transfer all the data across the network.

20. A method according to claim 19, wherein determining a highest throughput route during a first window of time or during a subsequent window of time comprises determining a cumulative capacity of each link of the network based on the predicted link utilisations and routing at least a portion of the data based on the cumulative capacities.

21. A method according to claim 20, wherein routing at least a portion of the data comprises using a generic routing engine.

22. A method according to claim 20, wherein determining a cumulative capacity of a link comprises determining a difference between a total capacity of the link and a predicted utilisation of the link.

23. A method according to claim 19, wherein the predicted link utilisations comprise a predicted utilisation value of each link in each of a series of time intervals, and each window of time is an integer number of consecutive time intervals.

24. A method according to claim 23, wherein determining the cumulative capacity of a link during a window of time comprises, for each of the consecutive time intervals of the window, determining a difference between a total capacity of the link and the predicted utilisation value of the link in the time interval, and summing the differences.

25. A method according to claim 23, wherein the time intervals are equal in duration.

26. (canceled)

27. A method according to claim 23, comprising deriving the predicted utilisation value of each link in a time interval by applying a generic routing engine to a demand matrix associated with the time interval.

28. A method according to claim 19, wherein, for each candidate schedule, the first window of time and any subsequent windows of time are consecutive.

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. A device comprising:
a machine-readable storage medium; and
executable program instructions embodied in the machine readable storage medium that when executed by a programmable system causes the system to perform a method according to claim 19.
